(19) United States
(12) Patent Application Publication
(10) Pub. No.: US 2013/0046597 A1
(43) Pub. Date: Feb. 21, 2013

(54) SYSTEM AND METHOD FOR PROVIDING PURCHASE REWARDS

(71) Applicant: W. Frank Fennell, Atlanta, GA (US)

(72) Inventor: W. Frank Fennell, Atlanta, GA (US)

(21) Appl. No.: 13/212,717

(22) Filed: Aug. 18, 2011

(51) Int. Cl. G06Q 30/02

(52) U.S. Cl. 705/14.23

(57) ABSTRACT

A system and method for providing purchase rewards to customers is disclosed. The system provides an online shopping interface through which users may purchase products from a plurality of online merchants. The user is awarded points based on the amount of money spent using the online shopping interface. The user is then able to redeem the points for use toward additional product purchases at a physical retailer location.

### TECHNICAL FIELD OF THE DISCLOSURE

The present disclosure relates to electronic commerce and, more specifically, to systems and methods for providing purchase rewards to customers for use at a physical retailer based on purchases made from an electronic commerce shopping interface.

### BACKGROUND OF THE INVENTION

The prevalence of online shopping websites has increased dramatically in recent years. As competition develops in the online sales sector, product manufacturers and online retailers are looking for new ways to attract customers. One method to increase sales is to provide rewards to the customer for using a particular method of purchase or for purchasing products through a particular website or online interface. However, known methods do not provide the customer with a convenient method to redeem their rewards at a particular location in which they already visit on a regular basis. Therefore, systems and methods are needed which allow consumers to redeem purchase awards at a single retail location while at the same time, providing benefits to both the online retailers and the physical retailer.

### SUMMARY OF THE INVENTION

According to one aspect, a system for providing purchase rewards is disclosed, comprising: a web server for communicating with an external client computer, said web server containing computer readable code for presenting an online shopping interface; and an award vehicle for redeeming purchase rewards at a physical retailer location; wherein said online shopping interface is configured to present product information for a plurality of products for display on said external client computer, said plurality of products being sold by merchants other than said physical retailer; wherein said online shopping interface is further configured to allow a user to select products for purchase using said online shopping interface and said external client computer; wherein the user is awarded points for purchases made through said online shopping interface; wherein said points may be redeemed for said award vehicle; and wherein the user is able to redeem said award vehicle toward purchases of products at said physical retailer location.

A kiosk for dispensing the award vehicle to the user may be optionally provided; said kiosk being located at the physical retailer location. A point-of-sale terminal may also be optionally provided, said point of sale terminal configured to access the user's point balance based on identification information read from the award vehicle. The web server may optionally be configured to transmit reward certificate information to a user's computing device, including mobile electronic devices and personal computers.

According to another aspect, a method for providing purchase rewards is disclosed, comprising the steps of: presenting a user with a customized online shopping interface, said interface displaying a plurality of products available for purchase by the user; receiving an order for at least one of said products from the user; adding points to an account associated with the user based on said order; and providing an award vehicle for the user to redeem said points for purchases at a physical retailer location; wherein the user is required to visit the physical retailer location to redeem said points for purchases; and wherein said plurality of products are sold by merchants other than said physical retailer.

According to yet another aspect, a device is disclosed, comprising a computer readable medium, said computer readable medium containing computer executable code for providing purchase rewards to customers; wherein: said computer executable code is configured to provide said purchase rewards according to a method comprising the steps of: presenting a user with a customized online shopping interface, said interface displaying a plurality of products available for purchase by the user; receiving an order for at least one of said products from the user; adding points to an account associated with the user based on said order; and providing an award vehicle for the user to redeem said points for purchases at a physical retailer location; wherein the user is required to visit the physical retailer location to redeem said points for purchases; and wherein said plurality of products are sold by merchants other than said physical retailer.

### BRIEF DESCRIPTION OF THE DRAWINGS

FIG. 1 is a schematic block diagram of a system for providing purchase rewards to customers according to one embodiment of the present disclosure.

FIG. 2 is a schematic flow diagram of a method for providing purchase rewards to customers according to one embodiment of the present disclosure.

### DETAILED DESCRIPTION OF THE PREFERRED EMBODIMENTS

For the purposes of promoting an understanding of the principles of the invention, reference will now be made to the embodiment illustrated in the drawings and specific language will be used to describe the same. It will nevertheless be understood that no limitation of the scope of the invention is thereby intended, and alterations and modifications in the illustrated device, and further applications of the principles of the invention as illustrated therein are herein contemplated as would normally occur to one skilled in the art to which the invention relates.

The present disclosure relates to a system and method for providing customers with purchase rewards for online purchases. An online shopping interface is provided which allows a customer to purchase products from a variety of participating online retailers. The user receives points based on a percentage of the amount of money spent on products using the online interface. The points may then be redeemed at a physical retail location for use toward the purchase of products from a participating physical retailer. There are a number of benefits to the described system. The online retailers receive the benefit of increased sales. The physical retailer receives the benefit of increased sales and customer visits to their physical retail location. The user receives the benefit of the earned points and credit towards purchases at the physical retailer. The system also provides a convenient method for users to consolidate and redeem points for use at the physical retailer.

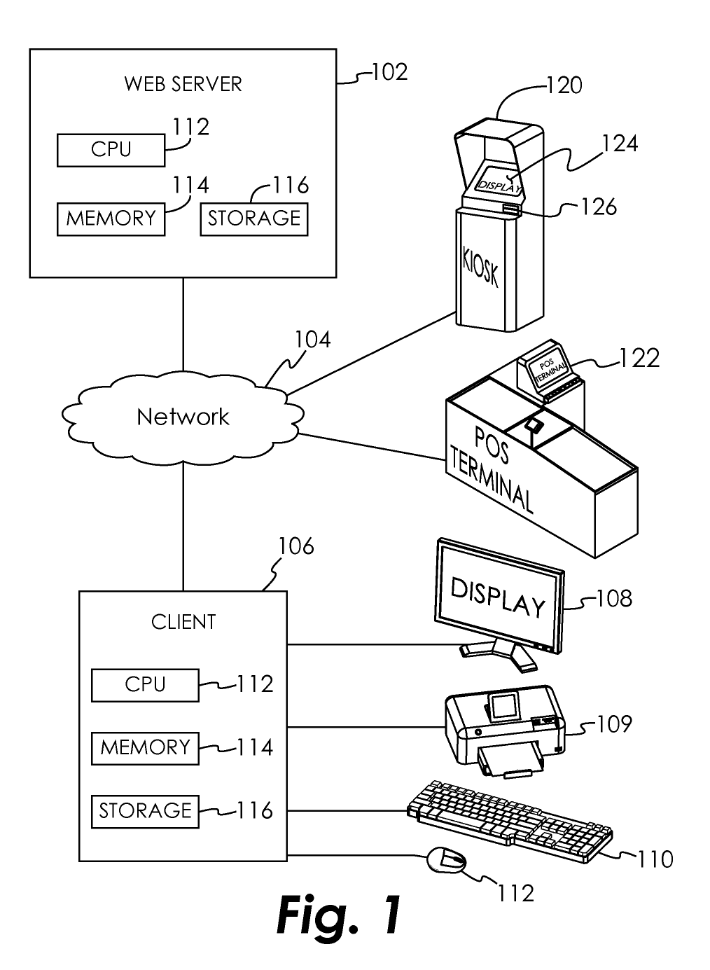

FIG. 1 shows a schematic block diagram of a system according to one embodiment of the present disclosure. System 100 includes web server 102, network 104, client 106, display 108, printer 109 and user input devices such as keyboard 110 and mouse 112. These devices are coupled to the client 106 to access customized product information from the server computer 102 and display the information for the user on display 108. The system may also include kiosk 120 and point of service (POS) terminal 122 for use at a physical retailer location. Kiosk 120 may include a display 124, printer 126 and user input devices similar to keyboard 110 or mouse 112 described hereinabove. POS terminal 122 and/or kiosk 120 may also include a card reading device which is configured to read and write data to and from an identification card, such as a credit card or debit card with a magnetic stripe. POS terminal 122 and/or kiosk 120 may also include a code reading device for scanning and retrieving codes or other imprinted data from a printed reward certificate or coupon. POS terminal 122 and/or kiosk 120 may also be configured to read other types of identification mediums, such as magnetic stripe cards, smart cards, radio frequency identification (RFID) tags or biometric identification (fingerprints, retinal scans).

The web server 102 may be implemented on a rack-mountable or blade server, a personal computer, a workstation computer, a laptop computer, a palmtop computer, or the like. It will be apparent to those of ordinary skill in the art that other computer system architectures may also be employed.

In general, the web server 102 comprises a bus for communicating information, a processor 112 coupled with the bus for processing information and a memory 114 coupled to the bus for storing information and instructions for the processor 112. A mass storage interface for communicating with a data storage device 116 containing digital information may also be included in the web server 102 as well as a network interface for communicating with the network 104.

The processors 112 may be any of a wide variety of general purpose processors or microprocessors such as the PENTIUM microprocessor manufactured by INTEL Corporation, a POWER PC manufactured by IBM Corporation, a SPARC processor manufactured by Sun Corporation, or the like. It will be apparent to those of ordinary skill in the art, however, that other varieties of processors may also be used in a particular computer system.

The memory 114 may include one or more types of solid-state electronic memory, magnetic memory, or optical memory, just to name a few. By way of non-limiting example, memory 114 may include solid-state electronic Random Access Memory (RAM), Sequentially Accessible Memory (SAM) (such as the First-In-First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM). Also, memory 114 may be volatile, nonvolatile, or a hybrid combination of volatile and nonvolatile varieties.

The mass storage interface may allow the processors 112 access to the digital information contained within the digital storage devices 116 via the bus. The mass storage interface may be a universal serial bus (USB) interface, an integrated drive electronics (IDE) interface, a serial advanced technology attachment (SATA) interface or the like, coupled to the bus for transferring information and instructions. The data storage device 116 may be a conventional hard disk drive, a floppy disk drive, a flash device (such as a jump drive or SD card), an optical drive such as a compact disc (CD) drive, digital versatile disc (DVD) drive, HD DVD drive BLU-RAY disc drive, or another magnetic, solid state, or optical data storage device, along with the associated medium (a floppy disk, a CD-ROM, a DVD, etc).

It shall be understood that the processors 112 may be comprised of one or more components configured as a single unit. Alternatively, when in multi-component form, a processor 112 may have one or more components located remotely relative to the others. One or more components of each processor 112 may be of the electronic variety defining digital circuitry, analog circuitry, or both.

Client 106 may be implemented using any of the computer architectures described above in relation to web server 102. Client 106 may further be implemented using a wireless mobile electronic device having computing capabilities, such as a mobile phone having a Windows CE™ or Palm™ operating system, a Blackberry™, an iPhone™ or the like. Client 106 may also comprise a processor 112, memory 114, mass storage interface, bus, network interface and storage devices 116 as described hereinabove in relation to web server 102.

The display 108 is coupled to the communication bus of client 106 for displaying information for a user and the input devices 110, 112 are coupled to the bus for communicating information and command selections to the processor 112. The display 108 may comprise a liquid crystal display (LCD), a cathode ray tube (CRT), a plasma monitor, an organic light emitting diode (OLED) display, or other suitable display device. Using the display 108, the user is able to view information regarding various goods for sale through the online shopping interface.

The printer 109 is coupled to the communication bus of client 106 for printing information being output to the communication bus. Using the printer 109, the user is able to print hard-copies of reward certificates or coupons for presentation at the physical retailer location.

Kiosk 120 may also be implemented using any of the computer architectures described above in relation to web server 102. Kiosk 120 may also comprise a processor 112, memory 114, mass storage interface, bus, network interface and storage devices 116 as described hereinabove in relation to web server 102. In a preferred embodiment, kiosk 120 is implemented as a single cabinet device having an integrated display 124 and printer 126. Input devices, such as keyboards, touchscreens, or mouse pointers may also be included in kiosk 120 as described above in relation to client 106.

In general, the processor 112 retrieves processing instructions and data from the data storage device 116 using the mass storage interface and downloads this information into random access memory for execution. The processor 112 then executes an instruction stream from random access memory or read-only memory. Command selections and information that is input at input devices 110, 112 are used to direct the flow of instructions executed by the processor 112. The results of this processing execution are then displayed on display device 108.

Web server 102, client 106, kiosk 120, and POS terminal 122 are able to communicate via network 104. Network 104 may comprise a Local Area Network (LAN), a Wide Area Network (WAN), the internet, or combinations thereof. In addition, network 104 may optionally incorporate wireless communications equipment and methods to facilitate communication between the web server 102, client 106, kiosk 120, and POS terminal 122.

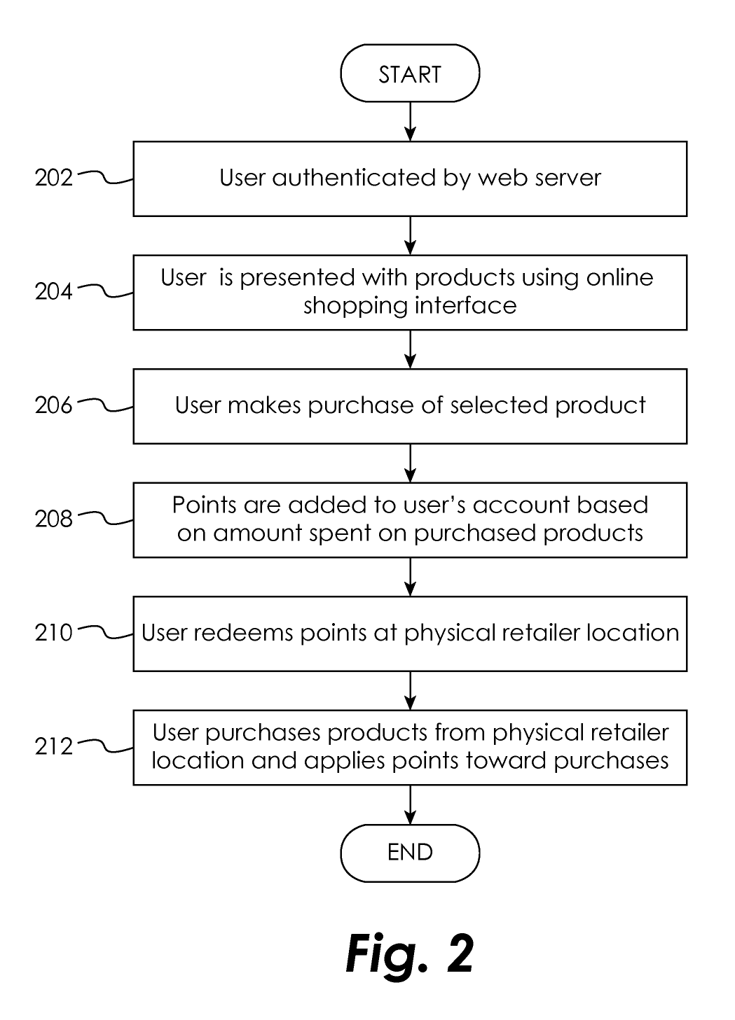

FIG. 2 illustrates a process for providing purchase rewards to customers according to one embodiment of the present disclosure. The process starts at step 202 when the web server 102 receives a request from the client 106. The request may be sent when the user enters a URL link, also known as a “web address,” into a web browser program on client 106. The URL link contains the address of a customized webpage with special pricing and product offerings. In certain embodiments, the URL link may be provided to the user as a hyperlink within an email or on an intranet website, wherein the user simply clicks on the URL link as opposed to manually typing the URL link into the web browser address bar. The request is typically in the form of a hyper text transfer protocol (HTTP) request, but other types of requests containing an embedded URL link are contemplated to be within the scope of the disclosure. After receiving the request, the web server 102 may optionally authenticate the user, such as by requesting a username and password from the user. In certain embodiments, a first-time user will be allowed to browse the site without being authenticated, thereby giving the user a chance to view the various features and available products before deciding whether to register. In still further embodiments, the web server 102 may authenticate the user based on the referring internet protocol (IP) address and/or the referring URL, without requiring the user to enter a username or password.

Once the user has been authenticated, the web server 102 generates product and pricing content information at step 204. As used herein, the term “generate” shall be interpreted to include the retrieval of pricing and product content with or without a real-time computation or determination of the prices and products to be displayed. The product information is then displayed for the user on display 108 in an HTML web page or other appropriate format. The products offered for sale are from merchants who have agreed to provide the products at a discount and/or have paid a fee to the system operator or the sponsoring physical retailer for the privilege of selling their products through the online interface. The fees paid by the online merchants may optionally be based on the amount of sales generated from users purchasing the online merchant's products.

At step 206, the user selects a product for purchase and completes payment. Payment may be facilitated by simply charging an account previously established by the user, or by having the user enter credit card information. In a preferred embodiment, the credit card used by the user is a co-branded card, such as a Visa card which is sponsored by the physical retailer.

At step 208, points are added to the user's account based on the amount of money spent by the user on products from the online interface. In one embodiment, the points are funded by the merchants whose products were purchased by the user. For example, if a user buys an item at a price of one hundred dollars, the system operator will retain a portion of the sales amount to fund the points which are credited to the user's account. In other embodiments, the points are funded by the product manufacturer. In still other embodiments, the points may be funded by the credit card company. The user continues to accumulate points as additional purchases are made.

After purchasing products using the online interface, the user may convert the points into award vehicles for use at the sponsoring retailer's physical store at step 210. The award vehicles may take any convenient form, such as coupons (physical or electronic), reward certificates, credit or debit cards, gift cards or other convenient forms. Electronic coupons and reward certificates may be sent to the user's mobile device, such as a mobile phone. The award vehicles are then used toward the purchase of products at the sponsoring retailer's physical locations at step 212. In one embodiment, the award vehicles may not be used to make purchases using the online interface—they may only be used at the retailer's physical location.

The points may be converted using a variety of methods, although the points may only be used to purchase products from the sponsoring retailer, thereby increasing the incentive for the user to travel to the sponsoring retailer's location for purchases. In one embodiment, the user may present an identification card, such as a branded loyalty card, to a cashier at the physical retailer when purchasing products at the physical retailer location. The cashier then scans the card using the POS terminal 122. The points are then credited toward the user's purchase and deducted from the user's account. In other embodiments, the user may select an option in the online shopping interface which directs the web server 102 to download an electronic reward certificate to the client 106. The reward certificate may then be printed using the printer 109 and presented to the cashier at the sponsoring retailer location.

In still further embodiments, the user may print a reward certificate using the kiosk 120 which is located within the physical retailer location. The kiosk 120 may include a user interface which allows the user to be authenticated and print the reward certificate for presentation to the cashier. The kiosk 120 may also be configured to dispense a gift card or other form of award vehicle for use with the disclosed system.

The printed reward certificates may include a bar code or other printed pattern which identifies the number of points and other relevant user information. It shall be understood that the reward certificates may also include other forms of encoding formats including one or two dimensional bar codes, optical holograms, computer-recognizable text and the like. It shall be further understood that the reward certificates may also include security features, such as watermarks, holograms and other anti-counterfeiting measures.

The above described system is particularly suitable for physical retailers who are visited by their customers on a regular basis such as grocery stores, gas stations, pharmacies, restaurants, movie theaters and convenience stores. It shall be understood, however, that the system may provide benefits for any merchant wishing to increase sales through their physical storefront channels. In many cases, the system may be operated at no cost to the sponsoring physical retailer, as the entire cost of the points may be funded by the online merchants. The online merchants, however, still benefit from the system due to the increased sales of their own products facilitated by the system.

The above-described system may be optionally configured to provide additional benefits and incentives for the users. For example, the online merchants may agree to offer certain products through the online shopping interface which are otherwise not available to the general public. Furthermore, the products listed through the online shopping interface may be offered with additional warranties or favorable return policies available only to user of the system.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A system for providing purchase rewards to a customer, comprising:
a web server for communicating with an external client computer, said web server containing computer readable code for presenting an online shopping interface; and
an award vehicle for redeeming purchase rewards at a physical retailer location;
wherein said online shopping interface is configured to present product information for a plurality of products for display on said external client computer, said plurality of products being sold by merchants other than said physical retailer;
wherein said online shopping interface is further configured to allow a user to select products for purchase using said online shopping interface and said external client computer;
wherein the user is awarded points for purchases made through said online shopping interface;
wherein said points may be redeemed for said award vehicle; and
wherein the user is able to redeem said award vehicle toward purchases of products at said physical retailer location.

2. The system of claim 1, wherein said award vehicle is a reward certificate.

3. The system of claim 1, wherein said award vehicle is a gift card.

4. The system of claim 1, further comprising a kiosk located at said physical retail location; said kiosk being configured to dispense said award vehicle to the user.

5. The system of claim 1, further comprising a point-of-sale terminal, said point of sale terminal configured to access the user's point balance based on identification information read from said award vehicle.

6. The system of claim 1,
wherein said web server is configured to transmit reward certificate information to a user's computing device.

7. The system of claim 6,
wherein said computing device is a wireless mobile electronic device.

8. A method for providing purchase rewards to customers, comprising the steps of:
presenting a user with a customized online shopping interface, said interface displaying a plurality of products available for purchase by the user;
receiving an order for at least one of said products from the user;
adding points to an account associated with the user based on said order; and
providing an award vehicle for the user to redeem said points for purchases at a physical retailer location;
wherein the user is required to visit the physical retailer location to redeem said points for purchases; and
wherein said plurality of products are sold by merchants other than said physical retailer.

9. The method of claim 8, wherein said award vehicle is a reward certificate.

10. The method of claim 8, wherein said award vehicle is a gift card.

11. The method of claim 8, further comprising the step of: providing a kiosk located at said physical retailer location; said kiosk being configured to dispense said award vehicle to the user.

12. The method of claim 8, further comprising the step of: providing a point-of-sale terminal, said point of sale terminal configured to access the user's point balance based on identification information read from said award vehicle.

13. The method of claim 8,
wherein said web server is configured to transmit reward certificate information to a user's computing device.

14. The method of claim 13,
wherein said computing device is a wireless mobile electronic device.

15. A device comprising a computer readable medium, said computer readable medium containing computer executable code for providing purchase rewards to customers; wherein:
said computer executable code is configured to provide said purchase rewards according to a method comprising the steps of:
presenting a user with a customized online shopping interface, said interface displaying a plurality of products available for purchase by the user;
receiving an order for at least one of said products from the user;
adding points to an account associated with the user based on said order; and
providing an award vehicle for the user to redeem said points for purchases at a physical retailer location;
wherein the user is required to visit the physical retailer location to redeem said points for purchases; and
wherein said plurality of products are sold by merchants other than said physical retailer.

16. The device of claim 15, wherein said award vehicle is a reward certificate.

17. The device of claim 15, wherein said award vehicle is a gift card.

18. The device of claim 15, wherein said method further comprises the step of: providing a kiosk located at said physical retailer location; said kiosk being configured to dispense said award vehicle to the user.

19. The device of claim 15, wherein said method further comprises the step of: providing a point-of-sale terminal, said point of sale terminal configured to access the user's point balance based on identification information read from said award vehicle.

20. The device of claim 15,
wherein said web server is configured to transmit reward certificate information to a user's computing device.
